(19) United States
(12) Patent Application Publication
(10) Pub. No.: US 2013/0021816 A1
(43) Pub. Date: Jan. 24, 2013

(54) PROJECTION HEADLAMP ARRANGEMENT FOR VEHICLES

(71) Applicant: Matthias Ehm, Lippstadt (DE)

(72) Inventor: Matthias Ehm, Lippstadt (DE)

(73) Assignee: Hella KGaA Hueck & Co., Lippstadt (DE)

(21) Appl. No.: 13/638,526

(22) PCT Filed: Mar. 31, 2011
(86) PCT No.: PCT/EP11/54894

§ 371 Date: Sep. 28, 2012

(30) Foreign Application Priority Data
Mar. 31, 2010 (DE) 1020100135585

(51) Int. Cl. B60Q 1/06

(52) U.S. Cl. 362/516

(57) ABSTRACT

A projection headlamp arrangement for vehicles with each headlamp containing a reflector with two focal points, a light source in a first focal point, a lens in front of the reflector with a focal point near the second focal point, and a shutter shaft between the lens and the reflector and adjustable into several positions about a rotational axis each of which has a shutter edge of the shutter shaft for creating a cutoff line an image capture unit detects objects in front of the vehicle, an image processing unit processes image data from the image capture unit, a marker light function sector of the shutter shaft has a shutter edge with an opening wherein the adjustment unit rotates the shutter shaft and/or pivots one or both of the headlamps about a vertical axis, so the object to be marked is illuminated by means of light passing through the opening.

The invention relates to a projection headlamp arrangement for vehicles with a left-hand projection headlamp and with a right-hand projection headlamp, each comprising a reflector with two focal points, a light source that is arranged in a first focal point of the reflector, a lens that is positioned in front of the reflector in the light-beam direction and whose focal point is arranged in the vicinity of the second focal point of the reflector, and a shutter shaft that is arranged between the lens and the reflector and that can be adjusted by means of an adjustment unit into several rotational positions about a rotational axis that extends horizontally and perpendicular to the optical axis, where-in one shutter edge of the shutter shaft is allocated to each of the rotational positions to create a cut-off line for a specified light distribution.

From EP 0 900 972 A1, a projection headlamp arrangement is known comprising left-hand and right-hand projection headlamps that have the same construction and are arranged at the corners of the front end of a vehicle. Herein, each headlamp has a light source, a reflector, a lens, and a shutter device that is arranged between the lens and the reflector. The shutter device has a shutter shaft that is arranged so that it can rotate about its own longitudinal axis and can be adjusted into several rotational positions. The shutter shaft is moved about the rotational axis that extends in the horizontal direction and perpendicular to the optical axis of the projection headlamp by means of an adjustment unit. The shutter shaft has four shutter edges that are arranged offset by 90° relative to each other in the rotational direction. By rotating the shutter shaft to a working position where one of the shutter edges is active, a cut-off line can be formed for the generation of a symmetric low-beam light distribution (basic, city, or adverse weather light pattern) or an asymmetric low-beam light distribution, a highway light distribution, or a high-beam light distribution. The known projection headlamp arrangement is limited to the reproduction of standard light distributions that do not allow an adaptation to the current traffic situation. The known projection headlamp arrangement has, in particular, no means for generating a marker light function. As described in DE 10 2008 025 947 A1, a marker light function is used to illuminate an object that is located in the region in front of a vehicle, for example, a person or animal crossing the street or a street sign. The goal of the marker light function is to selectively direct the driver's attention to objects in the region in front of the vehicle, so that he or she can react quickly to the traffic situation created by these objects.

The object of the present invention is to further develop a projection headlamp arrangement for vehicles so that, in addition to the number of light functions created by a contoured configuration of a shutter shaft, a marker light function can also be generated.

To solve this problem, the invention in connection with the preamble of claim 1 is characterized in that an image capture unit is provided for the detection of objects that are located in a region in front of the vehicle, that an image processing unit is provided for the processing of the image data that is generated by the image capture unit, that a light function sector of the shutter shaft is embodied as a marker light function sector with a shutter edge having an opening, wherein, in a marker light function, the adjustment unit, by means of a marker control signal, on one hand rotates the shutter shaft about the rotational axis of the shutter shaft and/or on the other hand pivots the left-hand projection headlamp and/or the right-hand projection headlamp about a vertical axis, so that at least a part of the object to be marked is illuminated by means of a partial light beam passing through the opening.

The special advantage of the invention consists in the fact that, in addition to a number of advantageously standardized light functions, a marker light function can also be generated by the contoured configuration of a shutter shaft of the projection headlamp arrangement. The marker light function is thus integrated in a spacing-saving manner in a headlamp operating according to the projection principle. The elongated shutter shaft that extends perpendicular to the main direction of the light beam has several light function sectors that extend in the circumferential direction of the shutter shaft. In the marker light function, the shutter shaft can be pivoted about a vertical axis and/or arranged so that it can pivot about a rotational axis of the shutter shaft, so that at least one part of the object to be marked can always be illuminated. The marker light function sector of the shutter shaft has a shutter edge that has, in some sections, an opening or a recess for the passage of a partial light beam that illuminates the object. Advantageously, the invention allows a marker light function to be integrated into a projection headlamp arrangement that is based on a shutter shaft without the need to change the installation space and without the need for additional components.

According to a further embodiment of the invention, an illumination height of the object to be marked is varied by rotating the shutter shaft about a rotational axis of this shutter shaft. Advantageously, in this way it is easily guaranteed that the object can always be identified as the relative distance of the vehicle to the object changes.

According to a further embodiment of the invention, the shutter shafts of a left-hand projection headlamp and of a right-hand projection headlamp are arranged so that they can be pivoted identically or individually by a pivot angle with respect to the vertical axis such that a specified or variable illumination width and/or a specified or variable luminous intensity of the object to be marked is adjustable. In order to achieve a high luminous intensity, for example, the marker light openings of the shutter shafts of the left-hand and the right-hand projection headlamp can be aligned to the same region of the object to be marked and therefore be superimposed. In order to achieve a relatively large illumination width of the object to be marked, the marker light openings of the two projection headlamps are aligned to different regions of the object to be marked. For example, a first partial region of the object can be allocated to the marker light opening of the left-hand projection headlamp and a second partial region of the object can be allocated to the marker light opening of the right-hand projection head-lamp.

According to a further embodiment of the invention, the only opening is arranged in a middle region of the shutter edge, so that by pivoting the shutter shaft about the vertical axis, a relatively large horizontal region of the region in front of the vehicle can be marked.

According to a further embodiment of the invention, adjacent contoured regions of the marker light shutter edge are embodied so that a low-beam light function can be generated. Advantageously, a light distribution can be generated in the marker light function that is essentially glare-free for the oncoming traffic and that allows a sufficient illumination of the region in front of the vehicle.

According to a further embodiment of the invention, the light source of at least one of the projection headlamps can be turned on and off in the marker light function at a specified frequency, so that the object to be marked is visually emphasized. This arrangement can increase the detectability of the object to be marked.

Further advantages of the invention are described in the other dependent claims.

One embodiment of the invention will be explained in more detail below by means of the drawings.

Shown are:

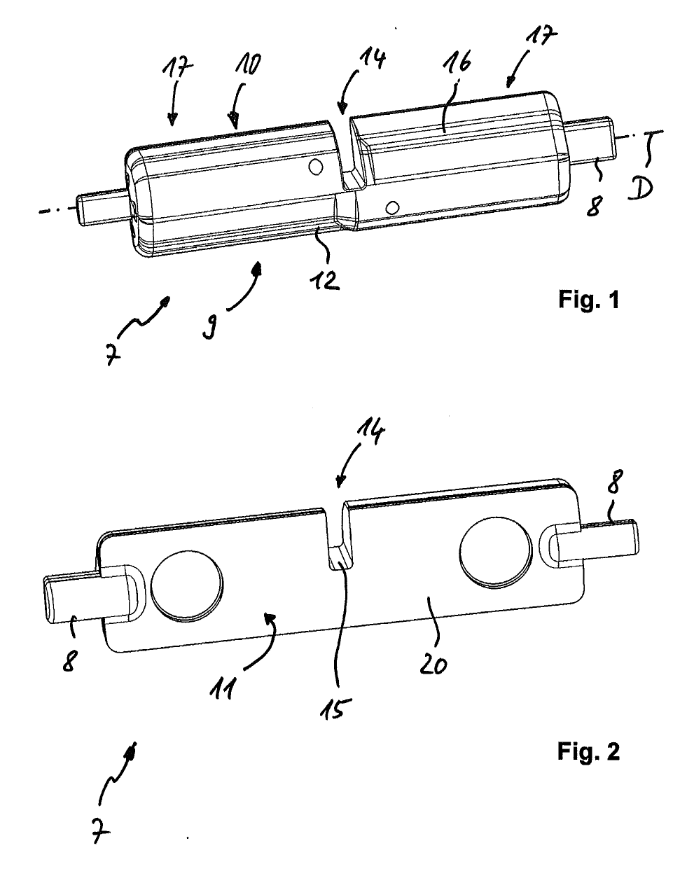

FIG. 1 A perspective representation of a shutter shaft seen from a first side,

FIG. 2 A perspective representation of the shutter shaft seen from a side opposite that of FIG. 1,

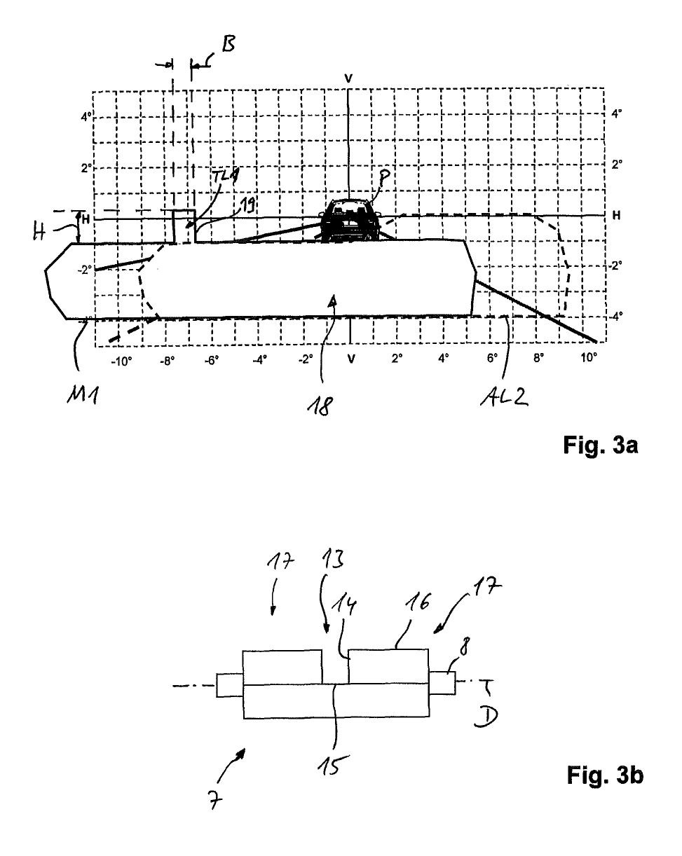

FIG. 3a A schematic representation of a marker light distribution, wherein a shutter shaft of the left-hand projection headlamp is located in a marker light position and a shutter shaft of the right-hand projection headlamp is located in a low-beam light position,

FIG. 3b A schematic vertical section through the shutter shaft of the left-hand projection headlamp located in the marker light position,

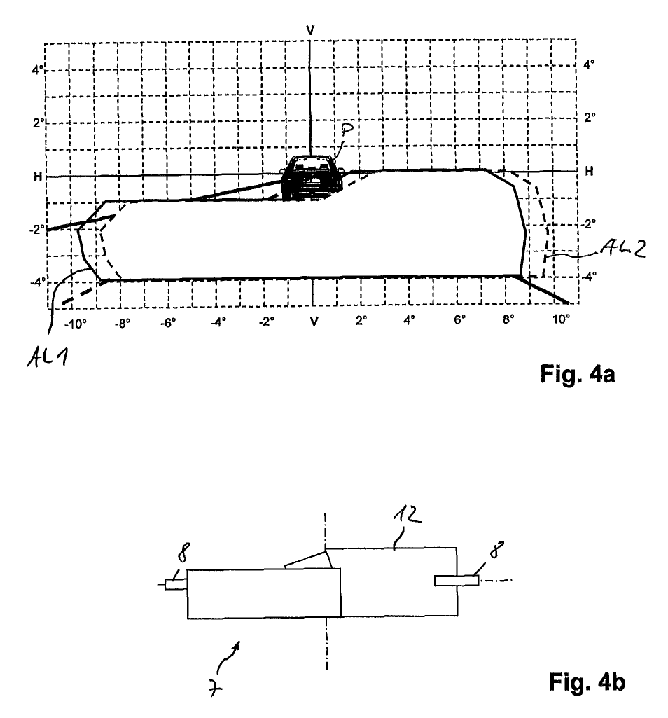

FIG. 4a A schematic representation of a low-beam light distribution, wherein the shutter shaft of the left-hand projection headlamp and the shutter shaft of the right-hand projection headlamp are located in the low-beam light position,

FIG. 4b A schematic vertical section through the shutter shaft in the low-beam light position with a 15° rise and

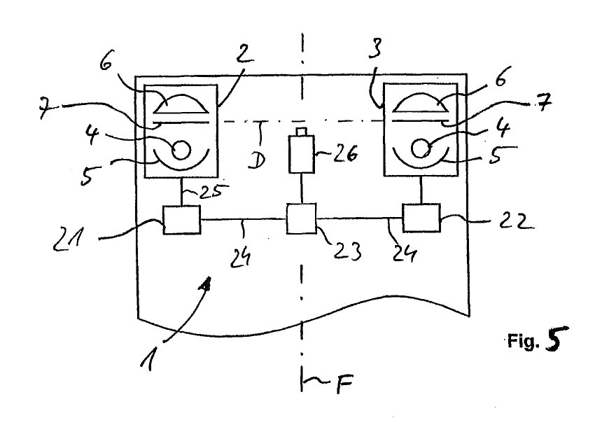

FIG. 5 A schematic top view of a vehicle with a projection headlamp arrangement consisting of the right-hand projection headlamp and the left-hand projection headlamp.

A projection headlamp arrangement 1 according to the invention essentially comprises a left-hand projection headlamp 2 and a right-hand projection headlamp 3. Each head-lamp is arranged at a corner of a front end of a vehicle.

As can be seen from FIG. 5, the left-hand projection headlamp 2 and the right-hand projection headlamp 3 both have a dish-shaped reflector 5 with a light source 4 that is arranged in the first focal point of this reflector. A lens 6 is arranged in the vicinity of a second focal point of the reflector 5. The left-hand projection headlamp 2 and the right-hand projection headlamp 3 have identical shutter shafts 7 and each shaft is arranged so that it can pivot about a horizontal rotational axis D. The rotational axis D extends horizontally and perpendicular to an optical axis of the reflectors 5. For the adjustment of the shutter shafts 7, adjustment units 21 and 22 are allocated to the shafts, respectively. An object recognition signal 24 provided by an image processing unit 23 is applied to the input of these adjustment units. The image processing unit 23 is used for the processing of image data being provided by an image capture unit 26. The image capture unit 26 can be embodied, for example, as a camera system covering the entire region in front of the vehicle (region of the road in front of the vehicle) and detecting objects located in this region, for example, people or animals at the edge of the street or street signs. The image capture unit 26 is embodied so that the position and/or the distance of the projection headlamps 2, 3 relative to the object to be marked in the region in front of the vehicle are recorded. The adjustment unit 21, 22 can comprise a microcontroller or a microprocessor with a memory holding a lighting control program.

The shutter shaft 7 has an elongated construction and is supported by means of end pins 8 so that it can rotate about the rotational axis D. The cross section of the shutter shaft 7 has a semicircular construction, wherein the shutter shaft 7 has, in the circumferential direction, at least three light function sectors 9, 10, and 11 for different light functions.

The first light function sector 9 is embodied as an adaptive low-beam light function sector that extends at a right-hand angle about the rotational axis D of the shutter shaft 7 and that has a multitude of shutter edges 12 extending essentially in the axial direction on a lateral surface of the shutter shaft. Different light distributions are allocated to the contours of these shutter edges. The shutter edge 12 can be contoured, for example, so that, in the low-beam light position, a cut-off line for the generation of an asymmetric low-beam light distribution is achieved for right-hand driving according to ECE standard, see FIG. 4b. A second shutter edge can be arranged in the circumferential direction offset by an acute angle relative to the shutter edge 12 and can be used to generate a city light distribution. In the first light function sector 9, additional shutter edges for a highway light distribution and the like can be arranged.

The second light function sector 10 is embodied as a marker light function sector. The marker light sector 10 extends in the circumferential direction of the shutter shaft 7 at an angle of approximately 90°. For example, the marker light function sector could also include an angle at circumference of less than or greater than 90°. Advantageously, the low-beam light function sector and the marker light function sector 10 span an angle at circumference of 180°. The marker light function sector 10 has, in a middle region 13 of the shutter shaft 7, a rectangular opening 14 with a base 15 that is arranged in the region of the rotational axis D. Regions 17 of the marker light function sector 10 adjacent to the opening 14 have an essentially circular or curved cross section, so that in the marker light position, essentially a straight shutter edge 16 that has the step-shaped opening 14 in the middle region 13 is active.

The opening 14 in the shutter shaft 7 or the shutter edge 16 makes it possible that at least one part of the object that is to be marked and is located in the region in front of the vehicle is illuminated, without dazzling other traffic participants, for example, on-coming vehicles or vehicles in front P. Herein, the object to be marked is illuminated by a partial light beam TL1 that passes through the opening 14. According to the embodiment shown in FIG. 3a, only the left-hand projection headlamp 2 is located in the marker light position while forming a marker light distribution M1 with a protruding section 19 for generating the marker light function, while the right-hand projection headlamp 3 is located in a low-beam light position while forming a low-beam light distribution AL2. The shutter regions 17 adjacent to the opening 14 correspond with their contours to a low-beam light distribution and thus allow a relatively large luminous intensity in a central region 18 of the overall light distribution composed of the marker light distribution M1 of the left-hand projection headlamp 2 and the low-beam light distribution AL2 of the right-hand projection headlamp 3.

To allow the partial light beam TL1 to follow the object to be marked in the horizontal direction, the left-hand projection headlamp 2 is arranged so that it can be pivoted together with the shutter shaft 7 by a pivot angle about a vertical axis. To set a specified illumination height H of the object to be marked, the shutter shaft 7 is rotated by a corresponding rotational angle about the rotational axis D. Preferably, the adjustment unit 21 acts upon an actuator adjusting the shutter shaft 7 of the projection headlamp 2 by means of a marker control signal 25, so that the object to be marked is always illuminated with an illumination height H adapted to the size of the object.

If the right-hand projection headlamp 3 is also located in the marker light function, a protruding section, not represented, of the marker light function of the second projection headlamp 3 can be superimposed with the protruding section 19 of the first marker light distribution M1. If the projection headlamps 2 and 3 have differing alignments with a differing pivot angle in the horizontal direction, the protruding sections 19 of the marker light distributions can be arranged one next to the other, for example, so that an illumination width is adjustable that is larger than an illumination width B of the protruding section 19. If the two protruding sections 19 of the left-hand and the right-hand projection headlamp 2, 3 overlap, then the luminous intensity in the region of the object to be marked can be increased.

Through a harmonized control of the first left-hand projection headlamp 2 and the right-hand projection headlamp 3, the illumination height H and the illumination width B can be set or adjusted in the region of the object to be marked.

Furthermore, the light sources 4 of the left-hand projection headlamp 2 located in the marker light function and/or the right-hand projection headlamp 3 can be turned on and off at a specified frequency, so that the object to be marked is visually emphasized and thus more easily perceivable for the driver. Because advantageously only one single projection headlamp 2 or 3 is controlled for this purpose and the other projection headlamp is located, for example, in the low-beam light function, sufficient illumination of the region in front of the vehicle is always given.

The third light function sector 11 is embodied as a high-beam light function sector that is arranged in angle at circumference region of 180° on a side opposite the low-beam light function sector 9 and the marker light function sector 10. Thus, an essentially flat surface 20 of the high-beam light function sector 11 is produced that generates a shutter edge for generating the high-beam light distribution by means of a corresponding rotational position of the shutter shaft 7.

As can be seen in FIG. 4a, for generating a low-beam light function, the shutter shafts 7 of both the left-hand projection headlamp 2 and the right-hand projection headlamp 3 are located in a rotational position in which the shutter edge 12 is active. A vehicle in front P is thus not dazzled.

According to one alternative embodiment, for the generation of the marker light function, the shutter shaft 7 of the right-hand projection headlamp 3 can be in a rotational position in which the shutter edge 16 is active for the generation of the marker light function, while the shutter shaft 7 of the left-hand projection headlamp 2 holds a rotational position in which the low-beam light shutter edge 12 is active for the generation of a cut-off line with a 15° rise.

According to one alternative embodiment, the opening 14 could also have a trapezoidal or triangular or curved construction instead of a rectangular construction. The essential feature is that the opening 14 is large enough for the illumination of at least a partial region of the object to be marked that is located above a cut-off line for the lowbeam light.

List of reference symbols

| | | | |
|---|---|---|---|
| 1 | Projection headlamp arrangement | H | Illumination height |
| 2 | Left-hand projection headlamp | B | Illumination width |
| 3 | Right-hand projection headlamp | D | Rotational axis |
| 4 | Light source | P | Vehicle |
| 5 | Reflector | M1 | Marker light distribution |
| 6 | Lens | AL1 | Low-beam light |
| | | | distribution |
| 7 | Shutter shaft | | |
| 8 | Pin | | |
| 9 | Light function sector | | |
| 10 | Light function sector | | |
| 11 | Light function sector | | |
| 12 | Shutter edge | | |
| 13 | Middle region | | |
| 14 | Opening | | |
| 15 | Base | | |
| 16 | Shutter edge | | |
| 17 | Shutter regions | | |
| 18 | Central region | | |
| 19 | Protruding section | | |
| 20 | Flat surface | | |
| 21 | Adjustment unit | | |
| 22 | Adjustment unit | | |
| 23 | Image capture unit | | |
| 24 | Object recognition signal | | |
| 25 | Marker control signal | | |
| 26 | Image capture unit | | |

1. A projection headlamp arrangement for vehicles with a left-hand projection headlamp and with a right-hand projection headlamp, with each headlamp containing:
a reflector with two focal points,
a light source that is arranged in a first focal point of the reflector,
a lens that is positioned in front of the reflector in the light beam direction and whose focal point is arranged in the vicinity of the second focal point of the reflector, and
a shutter shaft which is arranged between the lens and the reflector and which can be adjusted by means of an adjustment unit to several rotational positions about a rotational axis extending horizontally and perpendicular to the optical axis, wherein one shutter edge of the shutter shaft is allocated to each of the rotational positions to create a cut-off line for a specified light distribution,
wherein
an image capture unit is provided for the detection of objects that are located in a region in front of the vehicle,
an image processing unit is provided for the processing of the image data generated by the image capture unit,
a light function sector of the shutter shaft is embodied as a marker light function sector with a shutter edge having an opening, wherein, in a marker light function, the adjustment unit, by means of a marker control signal, on one hand rotates the shutter shaft about the rotational axis of the shutter shaft and/or on the other hand pivots the left-hand projection headlamp and/or the right-hand projection headlamp about a vertical axis, so that at least a part of the object to be marked is illuminated by means of a partial light beam passing through the opening.

2. The projection headlamp arrangement according to claim 1, wherein an illumination height of the object to be marked depends on a rotational angle of the shutter shaft about the rotational axis of this shutter shaft.

3. The projection headlamp arrangement according to claim 1, wherein the left-hand projection headlamp and the right-hand projection headlamp can be pivoted identically or individually about a pivot angle with respect to the vertical axis so that a specified or variable illumination width and/or a specified or variable luminous intensity of the object to be marked can be set.

4. The projection headlamp arrangement according to one of claim 1, wherein the light source of the left-hand projection headlamp and/or the right-hand projection headlamp can be turned on and/or off according to a specified frequency in the marker light function in order to visually emphasize the object to be marked.

5. The projection headlamp arrangement according to one of claim 1, wherein, for forming the marker light function, the shutter shaft of the left-hand projection headlamp and/or the right-hand projection headlamp is located in a rotational position in which the marker light function sector of the shutter shaft is active.

6. The projection headlamp arrangement according to one of claim 1, wherein the opening is arranged in a middle region of the shutter edge.

7. The projection headlamp arrangement according to one claim 1, wherein regions of the shutter edge adjacent to the opening are shaped so that a low-beam light distribution can be generated.

8. The projection headlamp arrangement according to one of claim 1, wherein the opening in the longitudinal cross section of the shutter shaft has a rectangular or trapezoidal or triangular or curved shape.

9. The projection headlamp arrangement according to one of claim 1, wherein the shutter shaft has, a low-beam light function sector for generating an adaptive low-beam light distribution and a high-beam light function sector for generating a high-beam light distribution as additional light function sectors.

10. The projection headlamp arrangement according to one of claim 1, wherein the marker light function sector (10) includes a rotational angle range of 90° about the rotational axis (D) of the shutter shaft (7).
